(19) United States
(12) Patent Application Publication
(10) Pub. No.: US 2007/0130047 A1
(43) Pub. Date: Jun. 7, 2007

(54) System and method for submitting trading orders

(76) Inventors: Matthew W. Claus, Summit, NY (US); Kevin M. Foley, New York, NY (US); Joseph C. Noviello, New York, NY (US); Howard W. Lutnick, New York, NY (US)

Correspondence Address: BAKER BOTTS L.L.P., 2001 ROSS AVENUE, SUITE 600, DALLAS, TX, 75201-2980, US

(21) Appl. No.: 11/499,296

(22) Filed: Aug. 4, 2006

Related U.S. Application Data
(60) Provisional application No. 60/705,774, filed on Aug. 4, 2005.

(51) Int. Cl. G06Q 40/00

(52) U.S. Cl. 705/37

(57) ABSTRACT

An apparatus for submitting trading orders comprises a memory and a processor. The memory stores a default value associated with a trader, and a trading order associated with the trader. The trading order comprises a total quantity of a product. The processor is coupled to the memory and determines a displayed quantity based on the default value. The processor determines a reserved quantity based on the determined displayed quantity and the total quantity. The processor communicates the trading order having the determined displayed quantity and the determined reserved quantity.

### RELATED APPLICATION

This patent application claims priority from Patent Application Ser. No. 60/705,774, filed Aug. 4, 2005, entitled: System and Method for Minimizing Keystrokes for Submitting Trading Orders.

### TECHNICAL FIELD OF THE INVENTION

The present invention relates generally to electronic trading and more specifically to a system for submitting trading orders.

### BACKGROUND OF THE INVENTION

In recent years, electronic trading systems have gained wide spread acceptance for trading of a wide variety of items, such as goods, services, financial instruments, and commodities. For example, electronic trading systems have been created which facilitate the trading of financial instruments and commodities such as stocks, bonds, currency, futures contracts, oil, and gold.

Many of these electronic trading systems use a bid/offer process in which bids and offers are submitted to the systems by a passive side and then those bids and offers are hit or lifted (or taken) by an aggressive side. For example, a passive trading counterparty may submit a “bid” to buy a particular trading product. In response to such a bid, an aggressive side counterparty may submit a “hit” in order to indicate a willingness to sell the trading product to the first counterparty at the given price. Alternatively, a passive side counterparty may submit an “offer” to sell the particular trading product at the given price, and then the aggressive side counterparty may submit a “lift” (or “take”) in response to the offer to indicate a willingness to buy the trading product from the passive side counterparty at the given price.

### SUMMARY OF THE INVENTION

In accordance with the present invention, the disadvantages and problems associated with prior electronic trading systems have been substantially reduced or eliminated.

An apparatus for submitting trading orders comprises a memory and a processor. The memory stores a default value associated with a trader, and a trading order associated with the trader. The trading order comprises a total quantity of a product. The processor is coupled to the memory and determines a displayed quantity based on the default value. The processor determines a reserved quantity based on the determined displayed quantity and the total quantity. The processor communicates the trading order having the determined displayed quantity and the determined reserved quantity.

Various embodiments of the present invention may benefit from numerous advantages. It should be noted that one or more embodiments may benefit from some, none, or all of the advantages discussed below.

One advantage is that a client device reduces the number of inputs, such as keystrokes, necessary for a trader to submit a given trading order. Once the trader keys into the keypad of the client device the total quantity of a trading order, the trader does not need to key in the displayed quantity or the reserved quantity of that trading order. Instead, the client device uses the default displayed quantity (or the default reserved quantity) to automatically determine the displayed quantity and the reserved quantity of a given trading order 12. By reducing the number of keystrokes required for a trader to submit a given trading order, the client device enables the trader to more quickly and more systematically submit trading orders for processing. Such an order-entry technique may also reduce the chance for input errors.

Other advantages will be readily apparent to one having ordinary skill in the art from the following figures, descriptions, and claims.

### BRIEF DESCRIPTION OF THE DRAWINGS

For a more complete understanding of the present invention and its advantages, reference is now made to the following description, taken in conjunction with the accompanying drawings, in which:

FIG. 1 illustrates one embodiment of a trading system in accordance with the present invention;

FIG. 2 illustrates one embodiment of trading information used by the system illustrated in FIG. 1; and

FIG. 3 illustrates a flowchart of an exemplary method for submitting trading orders.

### DETAILED DESCRIPTION OF THE INVENTION

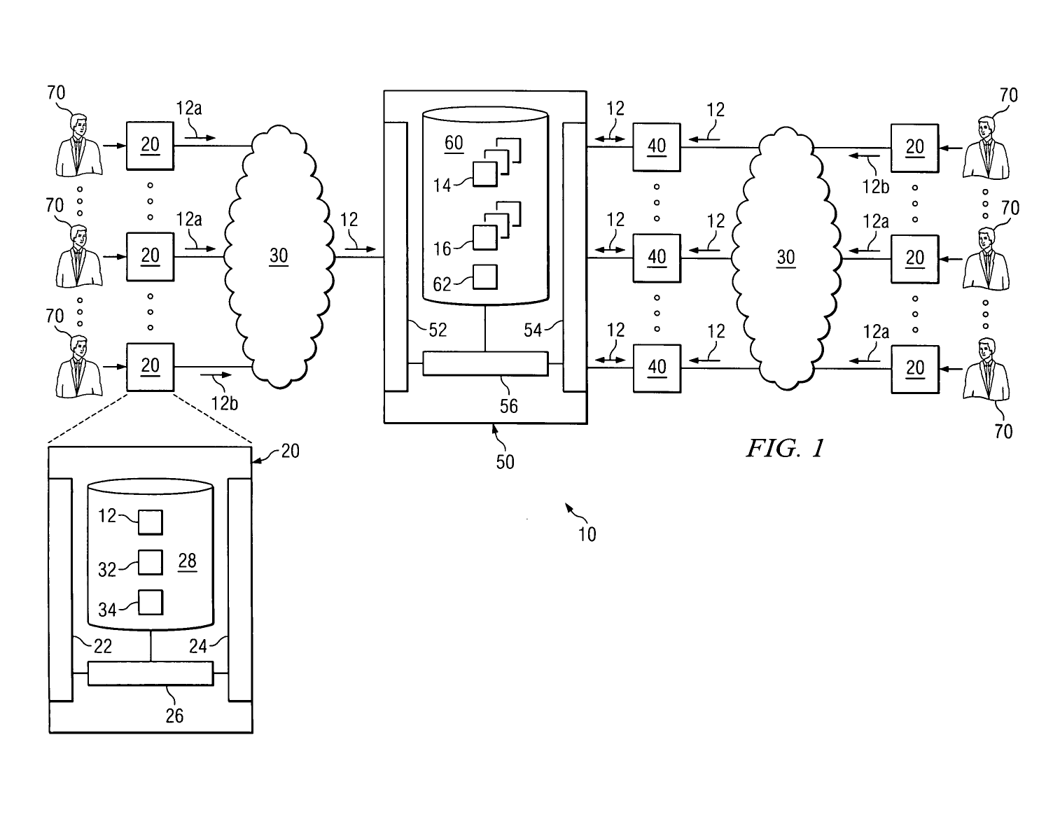

FIG. 1 illustrates one embodiment of a trading system 10. Generally, trading system 10 comprises a trading platform 50 communicatively connected to clients 20, networks 30, and market centers 40. Trading platform 50 may receive and process trading orders 12 from traders 70. By reducing the number of keystrokes required for trader 70 to submit a given trading order 12, the present invention enables trader 70 to more quickly submit trading orders 12.

A given trading order 12 may comprise two parts—a “displayed quantity” and a “reserved quantity.” In placing trading order 12, trader 70 may indicate that only a portion of the total quantity of trading order 12 should be displayed to other traders 70. This portion of trading order 12 to be displayed to other traders 70 is referred to as the “displayed quantity.” The remaining portion of trading order 12 is referred to as the “reserved quantity.” Designating a portion of trading order 12 as a “reserved quantity” allows trader 70 to enter a large trading order 12 while only displaying a portion of that trading order 12 to other traders 70. Generally, trading platform 50 may incrementally fill a particular trading order 12 by first filling the displayed quantity of that trading order 12 and then using the reserved quantity to replenish the displayed quantity of that trading order 12.

Trading orders 12 generally comprise orders 12a and counterorders 12b. Orders 12a and counterorders 12b may be buy orders 14 and sell orders 16. Orders 12a and counterorders 12b are complementary actions such as, for example, buying and selling. If an order 12a refers to a buy order 14, then a counterorder 12b refers to a sell order 16. Conversely, if an order 12a refers to a sell order 16, then a counterorder 12b refers to a buy order 14. A buy order 14 is a request to buy a particular quantity of a particular trading product (e.g., bid request). A sell order 16 is a request to sell a particular quantity of a particular trading product (e.g., offer request). In particular embodiments, trading order 12 may specify a target price (e.g., target bid price or target offer price) for the trading product. Although system 10 is exemplified below using equities as the trading product, the trading product that forms the basis of trading order 12 may comprise any goods, services, financial instruments, commodities, etc. Examples of financial instruments include, but are not limited to, stocks, bonds, and futures contracts.

Clients 20 are operable to receive trading orders 12 from traders 70 and to send trading orders 12 to trading platform 50 and/or market centers 40. Clients 20 comprise any suitable local or remote end-user devices that may be used by traders 70 to access one or more elements of trading system 10, such as trading platform 50. A particular client 20 may comprise a computer, workstation, telephone, Internet browser, electronic notebook, Personal Digital Assistant (PDA), pager, or any other suitable device (wireless or otherwise), component, or element capable of receiving, processing, storing, and/or communicating information with other components of system 10. Client 20 comprises a user interface 22, a network interface 24, a processor 26 and a memory 28 that are communicatively coupled to each other. User interface 22 may comprise any suitable interface, such as a display, microphone, keypad, keyboard, touch screen, or any other appropriate terminal equipment according to particular configurations and arrangements. Network interface may comprise any suitable combination of software and hardware to allow client 20 to communicate with network 30. It will be understood that there may be any number of clients 20 communicatively connected to trading platform 50. In addition, there may be any number of clients 20 communicatively connected to market centers 40 without using trading platform 50.

Memory 28 comprises any suitable arrangement of random access memory (RAM), read only memory (ROM), magnetic computer disk, CD-ROM, or other magnetic or optical storage media, or any other volatile or non-volatile memory devices that stores trading orders 12, logic 32, and one or more files, lists, tables, or other arrangements of information 34, such as default values for displayed quantities and/or reserved quantities. Generally, logic 32 comprises software instructions for determining trading orders 12. Although FIG. 1 illustrates memory 28 as internal to client 20, it should be understood that memory 28 may be internal or external to components of trading system 10, depending on particular implementations. Also, memory 28 illustrated in FIG. 1 may be separate or integral to other memory devices to achieve any suitable arrangement of memory devices for use in trading system 10.

Processor 26 may comprise any suitable combination of hardware and software implemented in one or more modules to provide the described function or operation. As described in greater detail below, processor 26 determines trading orders 12 using information 34 and/or by executing logic 32.

Although clients 20 are described herein as being used by “traders” 70, it should be understood that the term “trader” is meant to broadly apply to any user of trading system 10, whether that user is an agent acting on behalf of a principal, a principal, an individual, a legal entity (such as a corporation), or any machine or mechanism that is capable of placing and/or responding to trading orders 12 in system 10.

According to certain embodiments, traders 70 may include market makers. A market maker may include any individual or firm that submits and/or maintains either or both bid and offer trading orders 12 simultaneously for the same instrument. For example, a market maker may include an individual or firm, such as a brokerage or bank, that maintains either a firm bid and/or offer price in a given security by standing ready, willing, and able to buy and/or sell that security at publicly quoted prices. A market maker generally displays bid and/or offer prices for specific numbers of specific securities, and if these prices are met, the market maker will immediately buy for and/or sell from its own accounts. According to certain embodiments, a single trading order 12 may be filled by a number of market makers at potentially different prices.

Networks 30 are communication platforms operable to exchange data or information between clients 20 and trading platform 50 and/or market centers 40. According to certain embodiments, a particular network 30 may represent an Internet architecture which provides clients 20 with the ability to communicate trading or transaction information to trading platform 50 and/or market centers 40. According to certain embodiments, network 30 comprises a plain old telephone system (POTS), which traders 70 may use to perform the same operations and functions. Transactions may be assisted by a broker associated with trading platform 50 or manually keyed into a telephone or other suitable electronic device to request that a transaction be executed. In certain embodiments, network 30 may be any packet data network (PDN) offering a communications interface or exchange between any two nodes in system 10. Network 30 may further comprise any combination of local area network (LAN), metropolitan area network (MAN), wide area network (WAN), wireless local area network (WLAN), virtual private network (VPN), intranet, or any other appropriate architecture or system that facilitates communications between clients 20 and trading platform 50 and/or market centers 40.

Market centers 40 comprise all manner of order execution venues including exchanges, Electronic Communication Networks (ECNs), Alternative Trading Systems (ATSs), market makers, or any other suitable market participants. Each market center 40 maintains a bid and offer price for a given trading product by standing ready, willing, and able to buy or sell that trading product at publicly quoted prices, also referred to as market center prices. Different market centers 40 may provide different market center prices for particular trading products. For example, a particular market center 40 may offer a particular bid price and/or offer price for a particular trading product, while another market center 40 may offer a different bid price and/or offer price for the same trading product. A particular market center 40 may charge a transaction cost to execute trading orders 12 that remain in the order books of that market center 40 for more than a certain length of time. Different market centers 40 may have different policies regarding the disclosure of various details of trading orders 12. For example, certain market centers 40 referred to as “cooperative” market centers may disclose both the displayed quantities and the reserved quantities of trading orders 12 to trading platform 50. Other market centers 40 referred to as “non-cooperative” market centers may disclose only the displayed quantities of trading orders 12 to trading platform 50.

Trading platform 50 is a trading architecture that facilitates the routing, matching, and otherwise processing of trading orders 12. Trading platform 50 may comprise a management center or a headquartering office for any person, business, or entity that seeks to route, match, process, or fill trading orders 12. Accordingly, trading platform 50 may include any suitable combination of hardware, software, personnel, devices, components, elements, or objects that may be utilized or implemented to achieve the operations and functions of an administrative body or a supervising entity that manages or administers a trading environment. In certain embodiments, trading platform 50 comprises client interface 52, market interface 54, processor 56, and memory module 60.

Client interface 52 of trading platform 50 is communicatively connected to network 30 and supports communications between clients 20 and the various components of trading platform 50. According to certain embodiments, client interface 52 comprises a transaction server that receives trading orders 12 communicated by clients 20 via network 30.

Market interface 54 is communicatively connected to market centers 40 and supports communications between market centers 40 and the various components of trading platform 50. Market interface 54 may comprise a transaction server that receives trading orders 12 communicated by market centers 40. Market interface 54 may be operable to send to market centers 40 trading orders 12 received from clients 20 connected directly to trading platform 50.

Client interface 52 and market interface 54 are communicatively connected to processor 56. Processor 56 is operable to record trading orders 12 in memory module 60 and route trading orders 12 to market centers 40. Processor 56 is further operable to execute logic 62 stored in memory module 60 to match buy orders 14 and sell orders 16 received by client interface 52 and market interface 54. In addition, processor 56 is operable to incrementally fill a particular trading order 12 by using the reserved quantity of that trading order 12 to replenish the displayed quantity of that trading order 12. Processor 56 may comprise any suitable combination of hardware and software implemented in one or more modules to provide the described function or operation.

Memory module 60 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information such as trading orders 12. Although FIG. 1 illustrates memory module 60 as internal to trading platform 50, it should be understood that memory module 60 may be internal or external to components of trading system 10, depending on particular implementations. Also, memory module 60 illustrated in FIG. 1 may be separate or integral to other memory devices to achieve any suitable arrangement of memory devices for use in trading system 10.

According to certain embodiments, memory module 60 comprises logic 62. Generally, logic 62 comprises software instructions for routing, matching, processing, or filling trading orders 12. Processor 56 is operable to execute logic 62 to match buy orders 14 and sell orders 16 and to determine the priority of traders 70 associated with those buy orders 14 and sell orders 16. Processor 56 is further operable to execute logic 62 to determine the manner in which to replenish the displayed quantity of a particular trading order 12. Generally, the manner and sequence in which trading orders 12 are filled is based at least in part on the sequence in which trading platform 50 receives each trading order 12. In certain embodiments, the manner and sequence in which trading orders 12 are filled is also based at least in part on the size of the displayed quantity of a particular trading order 12 relative to the size of the reserved quantity of that trading order 12.

It should be understood that the internal structure of trading platform 50 and the interfaces, processors, and memory devices associated therewith is malleable and can be readily changed, modified, rearranged, or reconfigured in order to achieve the intended operations of trading platform 50.

Traders 70 may submit trading orders 12 to trading platform 50 by using clients 20. According to certain embodiments, client 20 may comprise a keypad, push buttons, touch screen, or other suitable means to enable trader 70 to input trading orders 12. According to certain embodiments, client 20 may be configured with a default value for trading orders 12. The default value may be used to determine the displayed quantities and/or reserved quantities of trading orders 12 submitted by a particular trader 70 for a particular trading product. In this regard, the default value may be referred to as the default displayed quantity or the default reserved quantity, depending upon the particular implementation.

For example, trader 70 may input a total quantity for trading order 12. If the total quantity of trading order 12 is more than the default displayed quantity, client 20 may set the displayed quantity of trading order 12 to be the default displayed quantity. Client 20 sets the remaining portion of trading order 12 as the reserved quantity of trading order 12. If the total quantity of trading order 12 is less than the default displayed quantity, then client 20 sets all of trading order 12 as the displayed quantity of trading order 12.

An example illustrates certain embodiments of the present invention. Trader 70a regularly submits buy orders 14 for product A. The displayed quantities of buy orders 14 regularly submitted by trader 70a typically have displayed quantities of less than 50 shares. Accordingly, trader 70a configures client 20 with a default displayed quantity of 50 shares. Subsequently, trader 70a decides to submit buy order 14a to trading platform 50 for 75 shares of product A. Using the keypad of client 20, trader 70a inputs 75 shares as the total quantity of buy order 14a. Client 20 sets the displayed quantity of buy order 14a to be 50 shares based on the default displayed quantity. In addition, client 20 sets the reserved quantity of buy order 14a to be 25 shares—the remaining portion of buy order 14a. In the present example, client 20 does not manually input into client 20 the displayed quantity of buy order 14a because client 20 automatically determines the displayed quantity of buy order 14a using the default displayed quantity.

According to certain embodiments, trader 70 may configure client 20 with a default displayed range. The default displayed range is a range within which trader 70 typically wants the displayed quantities of trading orders 12 to be. For each trading order 12 of trader 70, client 20 may randomly select a displayed quantity within the default displayed range. According to other embodiments, for each trading order 12 of trader 70, client 20 may select a displayed quantity within the default displayed range, the selection based on one or more formulas, algorithms, or tables. In still other embodiments, the default displayed quantity may itself be expressed as a formula, such as for example, “20% of total quantity.” In still other embodiments, the default displayed quantity may be a variable that is used in a formula to determine the displayed quantity, such as for example, “default displayed quantity=n; displayed quantity=n% of total quantity.” In these examples, the remaining portion of the trading order 12 is maintained as a reserved quantity.

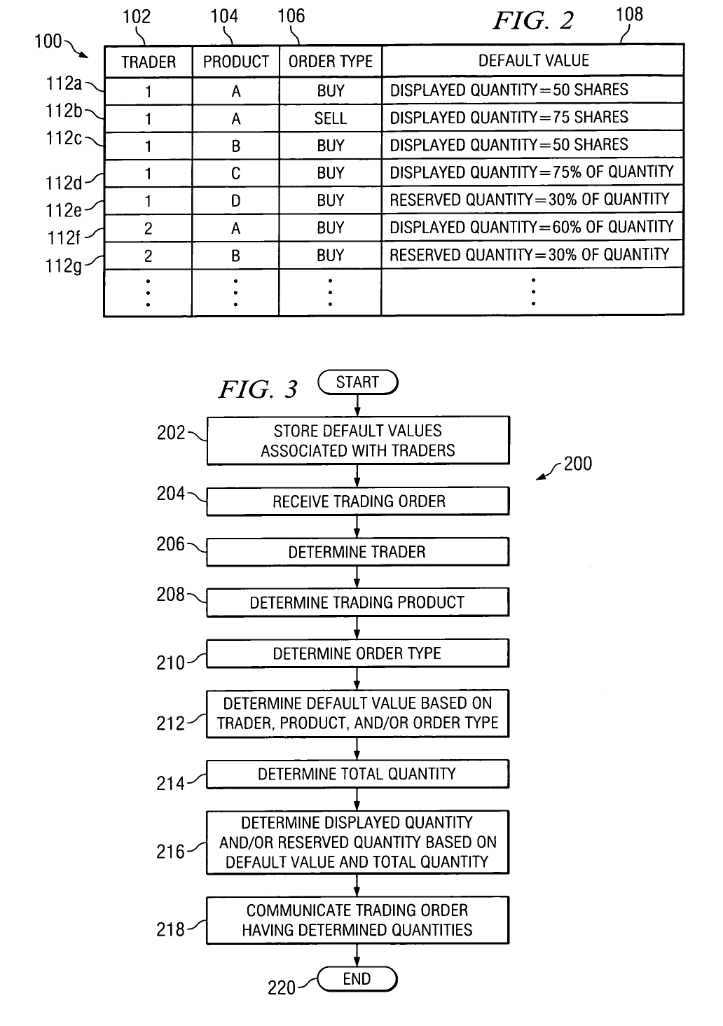

The variety of default displayed quantities may be associated with particular traders 70 and/or particular trading products, and stored in memory 28 of a client 20, such as information 34 stored in a table. Processor 26 uses the information 34 stored in memory 28 to create trading orders 12. One embodiment of information 34 is organized in a table that is illustrated in more detail in FIG. 2.

In some embodiments, for a particular trading order 12, trader 70 may override the default displayed quantity or range. For example, when inputting a particular trading order 12 into client 20, trader 70 may input a displayed quantity or range for that particular trading order 12 that is different from the default displayed quantity or range. For that particular trading order 12, client 20 may use the displayed quantity or range input by trader 70 to override the default displayed quantity or range.

System 10 has certain technical advantages. Various embodiments of system 10 may have none, some, or all of these advantages. One advantage is that the client 20 reduces the number of inputs, such as keystrokes, necessary for trader 70 to submit a given trading order 12. Once trader 70 keys into the keypad of client 20 the total quantity of trading order 12, trader 70 does not need to key in the displayed quantity of that trading order 12. Instead, client 20 uses the default displayed quantity to automatically determine the displayed quantity and the reserved quantity of a given trading order 12. By reducing the number of keystrokes required for trader 70 to submit a given trading order 12, client 20 enables trader 70 to more quickly and more systematically submit trading orders 12. Such an order-entry technique may also reduce the chance for input errors.

Although system 10 is described with reference to using a default displayed quantity, it should be understood that system 10 may also be implemented using a default reserved quantity without departing from the scope of the present disclosure. In these embodiments, client 20 determines the reserved quantity of a trading order 12 using a default reserved quantity or range, or by using formulas, algorithms, or tables as described above for a default displayed quantity. In addition, client 20 sets the displayed quantity to be the remaining portion of the trading order 12.

FIG. 2 is a table 100 that illustrates example information 34 organized in columns 102-108. Information 34 identifies a default value (column 108) according to a particular trader (column 102), trading product (column 104), and order type (column 106). For example, row 112a indicates that the default displayed quantity is 50 shares when trader 1 is attempting to buy trading product A. Row 112b indicates that the default displayed quantity is 75 shares when trader 1 is attempting to sell trading product A. Other default values for displayed quantities and/or reserved quantities may be used for trader 1 depending upon the trading product and the order type, as illustrated by rows 112c-e. In addition, other default values for displayed quantities and/or reserved quantities may be used for other traders 70 depending upon the trading product and the order type, as illustrated by rows 112f-g. Although default values are illustrated as being associated based upon trader, trading product, and order type, it should be understood that default values can also be associated with a variety of other parameters involved in system 10.

FIG. 3 is a flowchart 200 that illustrates one embodiment of a method for submitting a trading order 12. It should be understood that additional, fewer, or different operations may be performed in any suitable order to achieve the intended functions without departing from the scope of this method. At step 202, memory 28 stores default values associated with traders according to a variety of parameters, such trader, trading product and order type. The default values may be associated with displayed quantities and/or reserved quantities. Processor 26 receives trading order 12 at step 204 and determines the trader, the trading product, and the order type at steps 206-210, respectively. At step 212, processor determines the appropriate default value according to the parameters determined at steps 206-210. A step 214, processor 26 determines the total quantity associated with the trading order 12 received at step 204. Execution proceeds to step 216 where processor determines the displayed quantity and/or reserved quantity for the trading order based upon the default value determined at step 212 and the total quantity determined at step 214. Processor communicates the trading order 12 having the determined quantities at step 218. Execution terminates at step 220.

Although the present invention has been described in several embodiments, a myriad of changes and modifications may be suggested to one skilled in the art, and it is intended that the present invention encompass such changes and modifications as fall within the scope of the present appended claims.

What is claimed is:

1. An apparatus for submitting trading orders, comprising:
a memory operable to store:
a default value associated with a trader; and
a trading order associated with the trader, the trading order comprising a total quantity of a product; and
a processor coupled to the memory and operable to:
determine a displayed quantity based on the default value;
determine a reserved quantity based on the determined displayed quantity and the total quantity; and
communicate the trading order having the determined displayed quantity and the determined reserved quantity.

2. The apparatus of claim 1, wherein the trading order is received from the trader.

3. The apparatus of claim 1, wherein the displayed quantity is determined to be equal to the default value.

4. The apparatus of claim 1, wherein the displayed quantity is determined based upon a formula that uses the default value as a variable.

5. The apparatus of claim 1, wherein the reserved quantity is the difference between the total quantity and the displayed quantity.

6. The apparatus of claim 1, wherein:
the memory stores a first default value associated with the trader for a first product and stores a second default value associated with the trader for a second product; and
the processor determines the displayed quantity by:
determining a displayed quantity based on the first default value if the product associated with the trading order is the first product; and
determining a displayed quantity based on the second default value if the product associated with the trading order is the second product.

7. The apparatus of claim 1, wherein the processor determines a displayed quantity by:
setting the displayed quantity to equal the default value;
receiving a displayed quantity from the trader to override the default value; and
setting the displayed quantity to equal the displayed quantity received from the trader.

8. The apparatus of claim 1, wherein the processor determines a displayed quantity by:
determining that the default value comprises a range of values;
determining a value from the range of values; and
setting the displayed quantity to equal the determined value from the range of values.

9. The apparatus of claim 8, wherein the value from the range of values is determined randomly.

10. The apparatus of claim 8, wherein the value from the range of values is determined based at least in part upon a formula.

11. The apparatus of claim 1, wherein the default value comprises a percentage value and the processor determines the displayed quantity by applying the percentage value to the total quantity.

12. The apparatus of claim 1, wherein the apparatus comprises a client device.

13. A method for submitting trading orders, comprising:
storing a default value associated with a trader;
receiving a trading order associated with the trader, the trading order comprising a total quantity of a product;
determining a displayed quantity based on the default value;
determining a reserved quantity based on the determined displayed quantity and the total quantity; and
communicating the trading order having the determined displayed quantity and the determined reserved quantity.

14. The method of claim 13, wherein the trading order is received from the trader.

15. The method of claim 13, wherein the displayed quantity is determined to be equal to the default value.

16. The method of claim 13, wherein the displayed quantity is determined based upon a formula that uses the default value as a variable.

17. The method of claim 13, wherein the reserved quantity is the difference between the total quantity and the displayed quantity.

18. The method of claim 13, wherein:
storing comprises storing a first default value associated with the trader for a first product and storing a second default value associated with the trader for a second product; and
determining a displayed quantity comprises:
determining a displayed quantity based on the first default value if the product associated with the trading order is the first product; and
determining a displayed quantity based on the second default value if the product associated with the trading order is the second product.

19. The method of claim 13, wherein determining a displayed quantity comprises:
setting the displayed quantity to equal the default value;
receiving a displayed quantity from the trader to override the default value; and
setting the displayed quantity to equal the displayed quantity received from the trader.

20. The method of claim 13, wherein determining a displayed quantity comprises:
determining that the default value comprises a range of values;
determining a value from the range of values; and
setting the displayed quantity to equal the determined value from the range of values.

21. The method of claim 20, wherein the value from the range of values is determined randomly.

22. The method of claim 20, wherein the value from the range of values is determined based at least in part upon a formula.

23. The method of claim 13, wherein the default value comprises a percentage value and the displayed quantity is determined by applying the percentage value to the total quantity.

24. The method of claim 13, wherein the method is performed by a client device.

25. An apparatus for submitting trading orders, comprising:
a memory operable to store:
a default value associated with a trader; and
a trading order associated with the trader, the trading order comprising a total quantity of a product; and
a processor coupled to the memory and operable to:
determine a reserved quantity based on the default value;
determine a displayed quantity based on the determined reserved quantity and the total quantity; and
communicate the trading order having the determined displayed quantity and the determined reserved quantity.

26. The apparatus of claim 25, wherein the trading order is received from the trader.

27. The apparatus of claim 25, wherein the reserved quantity is determined to be equal to the default value.

28. The apparatus of claim 25, wherein the reserved quantity is determined based upon a formula that uses the default value as a variable.

29. The apparatus of claim 25, wherein the displayed quantity is the difference between the total quantity and the reserved quantity.

30. The apparatus of claim 25, wherein:
the memory stores a first default value associated with the trader for a first product and stores a second default value associated with the trader for a second product; and
the processor determines the reserved quantity by:
determining a reserved quantity based on the first default value if the product associated with the trading order is the first product; and
determining a reserved quantity based on the second default value if the product associated with the trading order is the second product.

31. The apparatus of claim 25, wherein the processor determines a reserved quantity by:
setting the reserved quantity to equal the default value;
receiving a reserved quantity from the trader to override the default value; and
setting the reserved quantity to equal the reserved quantity received from the trader.

32. The apparatus of claim 25, wherein the processor determines a reserved quantity by:
determining that the default value comprises a range of values;
determining a value from the range of values; and
setting the reserved quantity to equal the determined value from the range of values.

33. The apparatus of claim 32, wherein the value from the range of values is determined randomly.

34. The apparatus of claim 32, wherein the value from the range of values is determined based at least in part upon a formula.

35. The apparatus of claim 25, wherein the default value comprises a percentage value and the processor determines the reserved quantity by applying the percentage value to the total quantity.

36. The apparatus of claim 25, wherein the apparatus comprises a client device.
